(19) United States
(12) Patent Application Publication
(10) Pub. No.: US 2007/0043569 A1
(43) Pub. Date: Feb. 22, 2007

(54) System and method for inheritance of advertised functionality in a user interactive system

(75) Inventors: Laurence Potter III, Longwood, FL (US); Stephen A. Smith, Deltona, FL (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Intervoice Limited Partnership, Las Vegas, NV (US)

(21) Appl. No.: 11/208,028

(22) Filed: Aug. 19, 2005

(51) Int. Cl. G10L 21/00

(52) U.S. Cl. 704/270

(57) ABSTRACT

Systems and methods are described for use in user interactive systems (UIS) so that multiple disparate applications can cooperate to provide broad functionality to users. These systems and methods allow applications to advertise their ability to handle specific functions. This allows applications developed independently to co-exist within the same call session and provide a seamless user experience. A system framework controls the UIS's primary navigational menus, which are automatically updated when new applications are plugged in to the framework. This allows users (assuming they have the proper permissions) to access new applications as soon as they are added, without requiring programmers to manually re-design menus.

### CROSS-REFERENCE TO RELATED APPLICATIONS

The present application is related to concurrently filed, co-pending, and commonly-assigned U.S. patent application Ser. No. ______, Attorney Docket No. 47524-P132US-10415440, entitled “SYSTEM AND METHOD FOR ADMINISTERING PLUGGABLE USER INTERACTIVE SYSTEM APPLICATIONS,” and U.S. patent application Ser. No. ______, Attorney Docket No. 47524-P136US-10501427, entitled “SYSTEM AND METHOD FOR SHARING ACCESS TO SERVICE PROVIDER CONTROLS AND SUBSCRIBER PROFILE DATA ACROSS MULTIPLE APPLICATIONS IN A USER INTERACTIVE SYSTEM,” the disclosures of which are hereby incorporated herein by reference.

### TECHNICAL FIELD

This invention relates to user interactive systems (UIS), and more particularly to systems and methods which allow users to use functionality across applications in such UIS systems.

### BACKGROUND OF THE INVENTION

In certain situations, such as for example as discussed in the above-identified co-pending, and commonly-assigned U.S. patent application Ser. No. ______, Attorney Docket No. 47524-P132US-10415440, entitled “SYSTEM AND METHOD FOR ADMINISTERING PLUGGABLE USER INTERACTIVE SYSTEM APPLICATIONS”, multiple applications may be available to a system user, each application having different functions available to a system user. Each of the various applications may have been developed independently, and when they were developed, each application developer had no knowledge of what other applications might be made available to a user during a call. It is desirable that the system user be able to access any available application from any another application.

In multiple-application systems there are system navigation prompts that allow users to select the specific applications they would like to use. Usually these prompts explicitly describe all of the applications that are available to the user. This scheme is “explicit” prompting. Another type of application selection occurs when a user “asks” (or implies the need) for a certain result and that result is application specific. In such situations the application that the user is currently using must “know” the desired application-specific application in order to achieve the desired result. However, this presupposes that all applications know about all other applications and this is not the situation where applications from multi-vendors can be added (or removed) from a system at any time.

### SUMMARY OF THE INVENTION

Systems and methods are described for use in user interactive systems (UIS) so that multiple disparate applications can cooperate to provide broad functionality to users. These systems and methods allow applications to advertise their ability to handle specific functions. This allows applications developed independently to co-exist within the same call session to provide a seamless user experience. A system framework controls the UIS's primary navigational menus, which are automatically updated when new applications are plugged in to the framework. This allows users (assuming they have the proper permissions) to access new applications as soon as they are added, without requiring programmers to manually re-design menus.

In addition, when a new application is plugged in to the framework, new dynamic grammars are added to the dialog states in all of the other applications, This allows the system to detect when users in a specific application speak about other applications in the framework. When a user in one application speaks about another application, the system-added grammars help the system determine what application is being requested by the user, even though the original application was not designed to understand requests for other applications. In this way, users can navigate from one application to another, even when the other application choices were not known when the application was designed, and are not mentioned in the application prompts.

In one embodiment, certain grammars associated with an application are advertised for use by other applications such that when the grammar is detected by any of the other applications, the user at that other application is transferred to the application advertising the grammar. The user's context is maintained in the original application, allowing the user to return to that application at a later time, at the point where the user left off.

In still another embodiment, the transfer is contextual such that the same grammar used in different contexts will affect a transfer to different applications.

In one embodiment a system and method is shown for providing users with individual call flows that allow individual users to interact with a plurality of independently created applications in a manner proscribed by the user. In one embodiment, a profile manager associated with a subscriber controls the call flow presented to the caller so that the user will have uniformity across a number of independent applications without regard to the source of the application and without limitations put on the user by upgrades or changes to the user's equipment.

In one embodiment, the system allows each user to determine the prompts that will be provided and the media used to deliver the prompts can vary depending upon what method the user uses to access the applications. Thus, for a user on a telephone interface without a screen the prompts would all be verbal and in a particular order. This order can be within an application (i.e. departure flights first), or across applications for certain situations where the user has choices (banking, airline, database, etc.). Also, certain categories of choices are only available to certain users and perhaps only at certain times or under certain conditions. For a user on a GUI interface the prompts can be text, icons, voice, etc., and would typically use web applications and server interfaces.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment of a functional block diagram of a sample implementation of a user interactive system of the present invention;

FIGS. 2A and 2B illustrate one embodiment of a flowchart of system operation;

FIG. 3 illustrates one example of a central database used by all applications;

FIG. 4 illustrates one embodiment of navigation by grammar inheritance; and

FIG. 5 illustrates one embodiment of the application selection grammar control.

### DETAILED DESCRIPTION

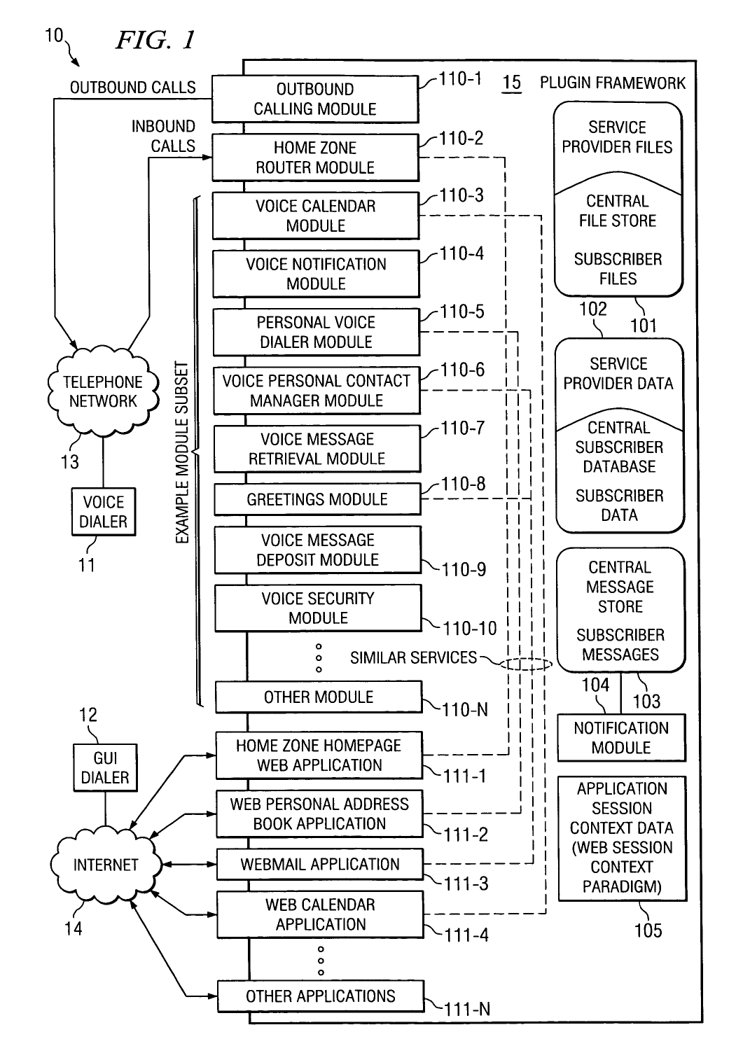

FIG. 1, illustrates one embodiment 10 of a user interactive system having plug and play modules (applications), such as modules 110-1 through 110-N, and modules 111-1 through 111-N, available for use in providing interactive services for users. In the embodiment shown, voice and DTMF and other analog interactions are handled from users 11 and telephone network 13 while users with graphical devices (typically using a GUI interface) interact with system 10 via a digital packet network, such as Internet 14.

Users can access the UIS using a variety of interactive devices, such as, for example, telephone using voice, MF or other inputs, computer, PDA, etc., using a web browser, interactive TV, cell phone, etc.

The discussion that follows illustrates voice type applications using modules 110-1 through 110-N, but many, if not all, of the applications, including the control thereof, can be accomplished by appropriate interface applications 111-1 through 111-4 to support other interface devices such as a PDA or Computer.

System 10 is designed to allow applications to be added or removed from the system without prior knowledge of any other application. Thus, using the concept discussed, it is possible for different applications to be designed by different designers (and different vendors) to be integrated into a framework that presents all applications functionality to the user in an integrated fashion without requiring reprogramming of any application. As will be discussed, there are at least these distinct operations, namely (1) provisioning the system for a user (or set of users); (2) advertising functionality of each application to other applications and/or the framework; and (3) shared access to data by all applications.

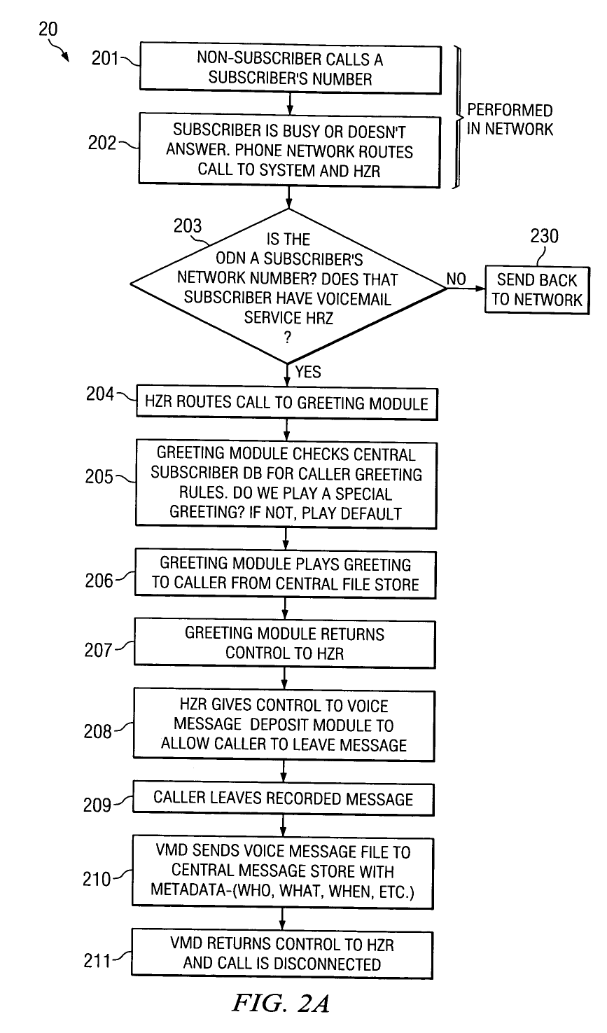

FIGS. 1, 2A, 2B describe the overall operation of the system, including all these operations. Before beginning the description of the system, it might be helpful to understand the difference between explicit prompts and implicit prompts in the context of any interactive system. Explicit promoting is when the system makes available in a visible or audible manner a list of all the then available selection choices. This introduces the idea that when new applications are plugged into the multi-application framework, the new application is automatically added to the choices explicitly described to the user (assuming the user has the appropriate class of service) in the main navigational prompts. This allows the user to explicitly select the newly-added application, as well as all the older existing applications during primary navigation.

Another type of prompt is the application-specific prompt, which usually is asking for information or selections in a single application. These types of prompts will not mention other applications, since when the prompt was created, other applications that might be available were not know. However, it is possible for a user in an application to ask for a feature that is in another application, even though the choice was not specifically presented in the application prompt. This is “implicit” prompting. Implicit prompting occurs when various applications advertise their capabilities to the plug-in framework. When a user requests functionality that is not available within a specific application, that application will pass control of the request to the plug-in framework, where all of the other applications functions are known. If another application can handle the request, the framework hands control of the call to the new application.

In this scenario, if the user indicates that he/she would like to perform the functions available in another application during an interaction, the system routes the user to the application that can handle the request. Since the first application's prompt menu did not list the second application function, the user simply asked for it. The system should maintain the previous application's context, so that when the second application is finished, the user can return back to the view where he/she left off in the first application.

In operation, as shown in embodiment 20, FIG. 2A, when a non-subscriber calls a subscribers number, network 13 handles the call in the traditional manner. If the called subscriber does not answer (or is busy), the network (as shown in process 202) routes the call to system 10. The incoming call is routed to module 110-2 (called the home zone router module). For ease of discussion, the home zone router (HZR) module can be thought of as a central module. Process 203 performs a series of tasks, some of which are a determination of whether an original dialed number (ODN) is a subscriber's number. If it is, then the system needs to determine if the subscriber has voicemail services.

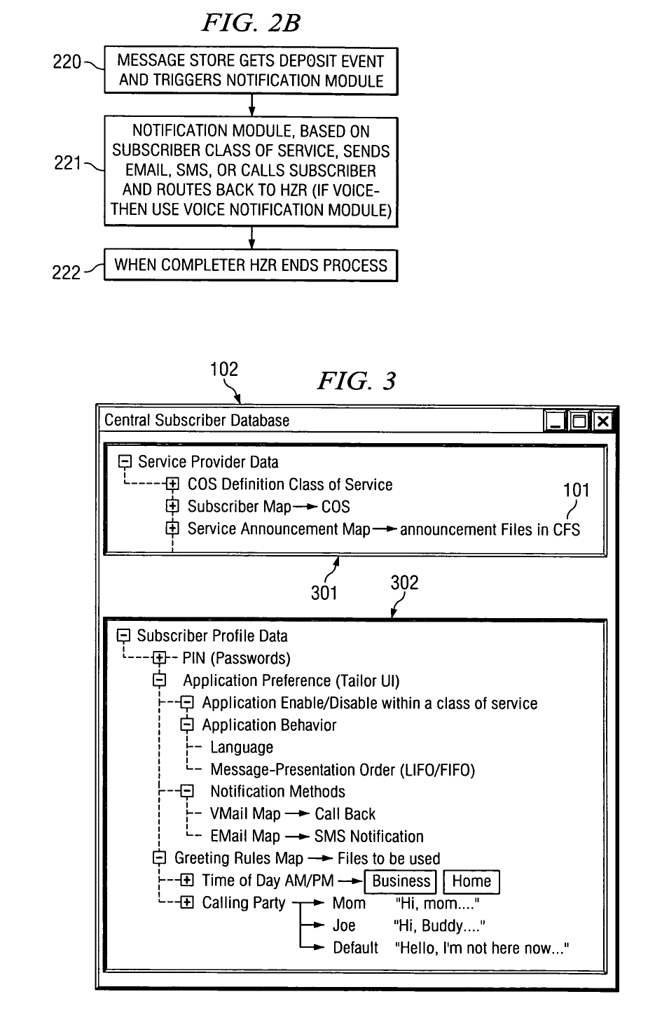

Once a positive determination is made, then the HZR module process 204, connects the call to greeting module 110-8. Greeting module 110-8, as shown by process 205, takes over control and checks central subscriber database 102 for the caller greeting rules pertaining to the called subscriber. One example of the central subscriber database is shown in FIG. 3 where section 301 is service provider data and section 302 is subscriber (profile) data. Depending on the data in section 302, process 206 plays the proper greeting as obtained from central file store 101. The files stored in the file store can be prerecorded by a professional, or by a user, and perhaps downloaded from a user's personal computer (PC).

Once greeting module 110-8 completes its task, process 207 returns control to home zone router (HZR) module 110-2 (which module acts as a control module) and process 208 gives control to voice message deposit (VMD) module 110-9 to allow the calling party to leave a message.

Process 209 receives the message and working in conjunction with process 210 stores the message in central message store 103 together with metadata pertaining to the call. The metadata can be, for example, time, calling party, length, special information, etc. When process 210 is finished, process 211 returns control back to HZR module 110-2 and the call is disconnected.

FIG. 2B illustrates the situation where, as shown in process 220, message store 103 has a message deposited (stored) therein. When this occurs, process 221, based on the subscriber's class of service, sends an email, an SMS message, or provides a voice message, indicating a message or provides the message, as desired by the user based on COS and the user's profile, as contained in central subscriber database 102 shown in FIGS. 1 and 3. If a voice call is to be made, module 110-4, in conjunction with module 110-1, are used to notify the subscriber. When the notification is complete, process 222 completes the call and the HZR ends the process.

As discussed above, all of the operations could be accomplished using applications 111-1 through 111-N, in which case home zone home page application 111-1 would perform similar to HZR 110-2. Note that the data in central file store 101, in central subscriber database 102 in central message store 103, in application session context data 105, and as well as the control processors in notification module 104, are available to all applications and modules regardless from where the information was obtained. Thus, once data is gathered from one application, whether on a session by session basis (database store 105), or on a more permanent basis (database store 102) that information can be shared, regardless of where an application was put into the system, and without regard to who designed the application. Also note that there are two types of data; volatile—which is kept in application session context 105 (FIG. 1), and non-volatile—which is kept in the central subscriber database (FIG. 1). The volatile data includes the states of various applications, security, etc., and is similar to the web session data. The non-volatile data includes data, such as the subscriber's address book, which is kept permanently in the database. Application modules share both types of data, as discussed, in the file.

Note that while not the normal situation, there can be more than one application that can perform a specific function. In such a situation, the HZR can select which application to use for a particular function at a particular time. This selection can be made in conjunction with the user profile (such as, “always use a module from a particular vendor, if available” or “use a calendar application compatible with brand ‘x’ calendar”).

FIG. 3 illustrates central subscriber database 102 having service provider data 301 and subscriber profile data 302. Some of the items within section 301 are class of service (COS) definitions established as an administrator; mapping of each subscriber to a COS definition and mapping of service announcement to announcement files in CFS 101. Some of the items within section 302 are subscriber PINS/Passwords; application preference, such as, which applications a subscriber wants (or does not want) within his/her COS; language; message presentation of order (LIFO/FIFO); notification methods; greet rules.

Using database 102, a subscriber has freedom of choice across many applications and can tailor the system to his/her likes and dislikes such that a change made while using one application (whether voice or GUI) will appear in other applications (whether voice or GU1).

Users can select the order of the function (order of a menu) desired and once that order is established for one application, the same order will apply to all modes of accessing the same (or similar) menus, whether the access is by voice, web server, video server, etc. While the user can specify an order of a prompt, the system can also statistically determine a preferred order and then apply the “inferred” order across applications and across media entry types, and across pluggable applications, all without prior knowledge among applications. Note that the statistics can be generated from a user based on calls using all media types (voice, web, video, text, graphics, etc.). Thus, if a user always asks for his/her bank balance first regardless of media type access, then the bank balance is the preferred first menu choice. However, if a user uses voice response for balances but text messaging for bank listings, then the system provides balances when the user calls in via a phone, but should check listings when the same user accesses the system via a web browser using text.

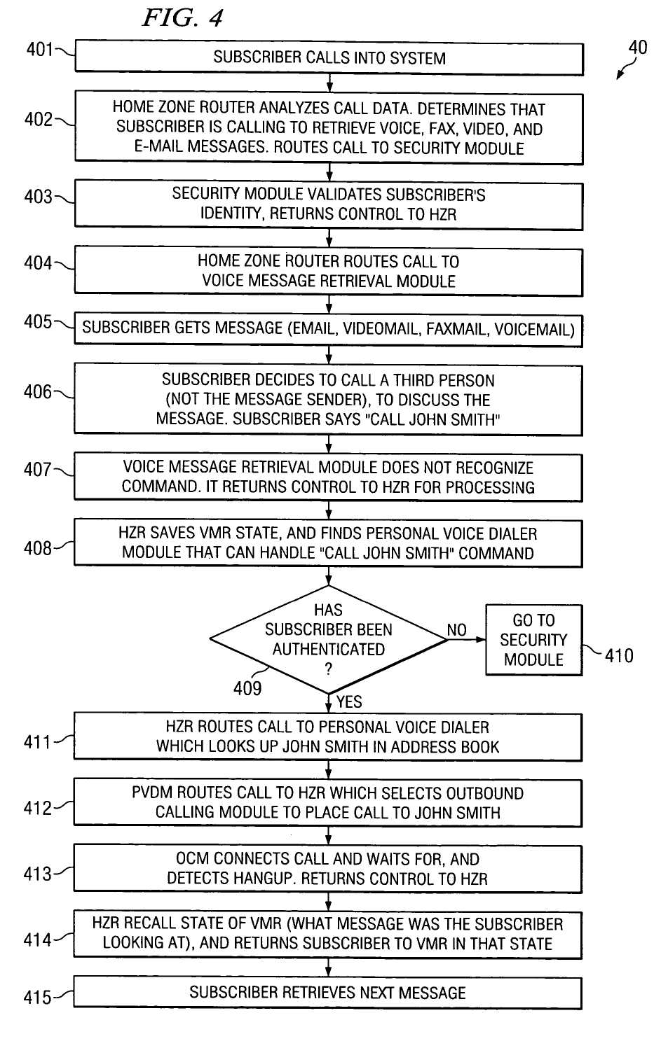

FIG. 4 illustrates one embodiment 40 of a flowchart showing navigation by grammar inheritance. Process 401 begins when a subscriber calls into the system. Process 402 is controlled by HZR 110-2 (FIG. 1) and determines that the caller is trying to obtain something from the system, such as, a voice mail, e-mail, video, etc. The incoming call is routed to a security module, such as, module 110-10 (FIG. 1) which, under control of process 403, validates the subscriber and, as will be discussed, stores the validation in a session database for this subscriber.

Note that as far as web or PDA accesses goes, the explicit prompting has a direct equivalent in the web, by adding graphics or text explicitly showing the user what choices they have. If new apps are plugged in, new graphics or text menu items are added to the web page. However, implicit prompting is much harder to implement on the web. Web-based applications with fixed text or graphical menus, typically do not allow user selections outside of those presented on the screen. If the user has six menu items to choose from, with a radio button to select the choice, there isn't any way for the user to specify other arbitrary choices. An entry box could be provided to allow the user to describe other implicit choices, if desired.

For example, let us assume that a user is in the middle of an airline function (perhaps inquiring about a flight landing time) and the user decides to ask for weather conditions at a certain city. Today, it is usually the case that the application the user is interacting does not contain a weather reporting function and thus can not respond to the user request. In those situations, the user must exit the current application and then log into the proper application to obtain the desired information. Then the user must reactivate the original application and again enter all the desired information even though much if not all of that information had been entered in the prior session. This issue is particularly onerous with a voice interface, where all interaction threads are serial, and context switching is more difficult for the user. This is a waste of the user's time as well as a waste of system resources.

The problem is further compounded when, as discussed in the co-ending, and commonly-assigned U.S. patent application Ser. No. ______, Attorney Docket No. 47524-P132US-10415440, entitled “SYSTEM AND METHOD FOR ADMINISTERING PLUGGABLE USER INTERACTIVE SYSTEM APPLICATIONS,” many vendors supply individual applications for use by a user, perhaps in a pluggable manner, and thus, the current application may not even “know” about an application that could handle the user's implicit prompt.

Returning to FIG. 4, process 404 then causes HZR 110-2 to route the call to voice message retrieval module 110-7 (FIG. 1) so that the subscriber can return his/her message under process 305 in the form set out in the subscriber's profile in database 102, as discussed above.

Assume now the subscriber decides to call a third party (not the party who left the message) to discuss the message. In such an event, the subscriber might say, “Call John Smith.” Since retrieval module 110-7 does not recognize the command “call . . . ”, it cannot comply with the direction. However, it can, and does, return temporary control of the session back to the HZR for further processing via process 407.

The home zone router saves the state of the existing session and finds the personal voice dialer 110-5 that can handle the command “call . . . ”. When the proper module is selected process 409 determines if this subscriber has been authenticated for performing this service. If not, then process 410 sends the subscriber to a security module. If the subscriber had been authenticated in a previous interaction with a module, that authentication would have been saved in the session data for this subscriber, and then the home zone router would route the call to the personal voice dialer selected which would then looking up “John Smith” in the address book for this subscriber. The address book would, for example, be located in central subscriber database 102 (FIG. 1). The personal voice module would then route the call back to the home zone router via process 410 which would select an outbound calling module such as module 110-1 to place the call to “John Smith” process 413 connects the call under control of the outbound call module and the text answer “hang-up” and other supervisory functions, and when the call is complete it is returned to the home zone router at process 414. The home zone router then recalls the state of the session, and more specifically determines what message the subscriber was listening to when the subscriber placed the third party call. The home zone router then returns the subscriber to the voice message retriever module in the same state that it was when the call was rerouted. The subscriber then retrieves the next message via process 415. This system then iterates through all the messages until there are no more messages and then turns to home zone router for completion of the session under control of the subscriber.

Note that processes 406-409 demonstrate how the home zone router can switch from module to module depending upon commands introduced by a subscriber or by a non-subscriber. Which commands are not known to the specific application, but which are contained in a set of lists maintained under the command of the home zone router. These lists were compiled from time to time as new modules are placed into the system. The modules then advertise their availability and the words and interactions that they can perform so that the home zone router then, upon detecting a phrase or word or direction, can select an appropriate module for processing the call at that point.

For example, a person might be talking to a interactive application, for example, to book a flight to a vacation destination. The application may say “would you like to book the flight?” The expected responses, of course, are yes, no, maybe, but one expected response would not be “where is the hurricane?”. Accordingly in traditional systems this cannot be processed, but in the system being discussed the phrase “where is the hurricane?” would be passed back to the home zone router because the application did not know what to do with the response. The home zone router would then look into its list and see which of the modules has advertised the fact that that module would handle the phrase “where is the hurricane?”. The home zone router would then transfer control of the session to the weather module which had advertised that it could handle various weahter related phrases including the phrase “hurricane”. The subscriber would then hear a message that would say, “Did you want information about the location of the hurricane?”. If the user answers yes, then that application would go on and process and provide the information to the user. When the user is finished, the user might say, “Okay, I am ready to book my flight”. The hurricane application would have no capability to understand, “Book my flight”, so it would return control to the home zone which would know that the subscriber desires to return to the application previous entered. The user should resume interacting in the flight booking application just where the user left off previously.

The home zone router could listen to the message from the subscriber and determine that the subscriber wants to go to another application, because perhaps the subscriber would like to know about his/her banking account. The home zone router could then provide such applications, and when they are finished they would return to the subscriber to the original application at the same point in the application where the subscriber left the application when the subscriber said, “where is the hurricane?”. In this manner seamless operation between different applications designed by different designers at different times is available even though the applications do not know about the existence of the other applications.

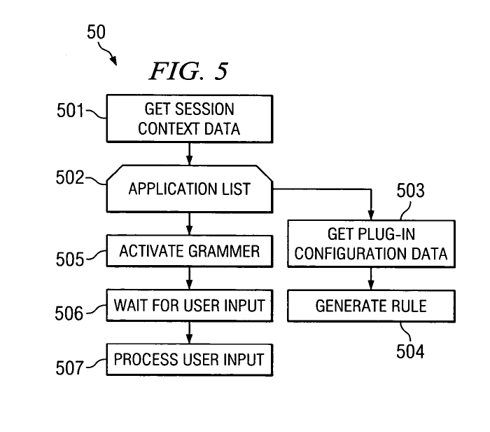

Process 411 routes the call to personal voice dialer 110-5 which then looks up “John Smith” in database 102. The personal address book of the subscriber, such as address book 502 (FIG. 5), of database 102 (FIG. 1). Note that address book 500 for this subscriber is available for use by all applications 110-1 to 110-N and 111-1 to 111-N (FIG. 1).

Once the calling number (or other identification) is obtained from the personal book of the subscriber (or from a common location for certain names), process 412, under control of the HZR, selects an outbound calling module, such as module 110-1, and places the call through the network to “John Smith”.

Process 413 monitors the call for termination and when the call is finished, system (framework) control goes back to the HZR which then, under process 414 recalls the state of the session and returns the subscriber to where the subscriber was, i.e., in VMR module 110-7, for continuation of the message retrieval process (process 415) that was interrupted when the subscriber asked to “call John Smith”.

Note, there are two methods to implement the implicit navigation. One method occurs when an application receives a “no match” from the ASR on an utterance, it hands the control and the utterance to the framework and the framework analyzes the utterance with a broader grammar that encompasses the functionality of all of the plugged-in applications. The second method is having the framework stick additional dynamic grammars (i.e. from other plugged-in applications as they are added to the system) in each prompt recognition to handle all of the possible requests. The second method is preferred with current ASR engines, even though larger grammars are required in each application.

FIG. 5 illustrates one embodiment 50 of the application selection grammar control. Process 501 gets information from the session context data, such as the interface mode and available applications. Process 502 loops through each available application performing processes 503 and 504. Process 503 gets plug-in data necessary to build the grammar via plug-in manager business objects. Process 504 then generates a rule which can be used to detect that the user wants to perform the application the rule applies to.

Process 505 activates the generated grammar and generates a document. The system then waits for user in put. Process 506 then processes the user input. For example, if the user accessed the system via a voice activated telephony interface, the document generated would most likely be an inline grammar XML (GRXML), grammar processed by an automatic speech recognition (ASR) server.

After user input, an ASR server provides information related to which grammar item best matched the user input, what its confidence is, that the match is correct, as well as tags defined by the application selection grammar. This information is returned to the calling application, such as the HZR which then enables the “target” application.

The open messaging system is a fully pluggable environment, meaning that on any given system a different set of plug-in applications may be installed. Even common plug-in applications may be replaced with other plug-in applications. For example, a security plug-in application which verifies a subscriber using PIN entry could be replaced with one using voice verification. Further, available applications can vary by service provider, call type, class of service, and by user (subscriber). Therefore, the open messaging structure is implemented such that it is dynamic and makes no assumptions as to the configuration of the system beyond the required framework.

The application selection menu must therefore be dynamic, given that it may change by access method or user and may even change during the session based on input from the user. Thus, application selection menu is implemented as a java server page (JSP) which generates a document, for example GRXML, which is used to process user input.

The document generated utilizes the plug-in manager business objects such that information unique to available applications can be included. Taking GRXML document as an example, each application would result in an item containing a <ruleref> which references a grammar provided by the application.

The document would also provide information provided by the plug-in manager business objects which is returned to the calling application in order to process the user input. For example, a set of tags generated in a GRXML document for each item which include the plug-in application name, voice link name and confirmation URL. The plug-in application name and voice link name are used by the calling application to derive a URL for the selection application so that the user may be transferred to the selected application. If the calling application deems it necessary to confirm the user input, the confirmation URL is a routine provided by applications in order to confirm that the user selected an item within the grammar provided by said application.

The home zone router, or any application launched by the router, may utilize the application selection grammar. Because the application selection grammar may be accessed from different browsers or browser sessions, the URL is dynamic. Therefore, when the router launches an application it passes as a parameter, SelectionGrammar, the URL for the application selection grammar.

When a new web application is plugged in, its' functionality is automatically added to the Home page navigational menu, either by adding text menu selections or more clickable icons (explicit navigation). When the user is in a specific graphical application, there could be a pull-down menu on every page, where the number of choices on the pull-down is modified whenever the administrator plugs in another application (implicit navigation). This pull-down list provides the same functionality as the inherited grammars.

The following is a sample VXML script which invokes the application selection grammar. This is only an example and is not intended to be functional.

```
    <?xml version=”1.0”?>
    <vxml version=”2.0” xmlns=http://www.w3.org/2001/vxml>
    <form>
          <var name=”SelectionGrammar”/>
        <field name=”application selection”>
                <!-- Play Prompts -->
        <grammar type=‘application/srgs+xml’mode=‘voice’
srcexpr=‘SelectionGrammar’/>
            <noinput>
                <!-- No response from user -->
            </noinput>
            <nomatch>
                <!-- No match on user input -->
            </nomatch>
            <error>
                <!-- A grammar error was encountered -->
            </error>
            <filled>
                <!-- handle user input -->
            </filled>
        </field>
    </form>
```

The following is a sample GRXML script which references grammars for applications called Deposit and Retrieval. This is only an example and is not intended to be functional.

```
<?xml version=”1.0”?>
<grammar root=“AppSelection” type=“application/srgs+xml”
  mode=“voice” version=“1.0” xml:lang=“en-US”>
<rule id=“AppSelection” scope=“public”>
  <one-of>
    <item>
      <tag>
        GRAMMAR=‘AppSelection’;
        APP=‘Deposit’;
        CMD=’Deposit’;
        CONFIRM=‘Deposit.vxml#Confirm’
      </tag>
      <ruleref uri=“Deposit/grxml/en-US/female/deposit.grxml”
        type=“application/srgs+xml”/>
    </item>
    <item>
      <tag>
        GRAMMAR=‘AppSelection’;
        APP=Retrieval;
        CMD=Retrieval;
        CONFIRM=’Retrieval.vxml#Confirm’
      </tag>
      <ruleref uri=“Retrieval/grxml/en-US/female/retrieval.grxml”
        type=“application/srgs+xml”/>
      </item>
    </one-of>
  </rule>
  </grammar>
```

In the example in paragraph [0029], the tags are defined as follows:

| Tag | Definition | Comment |
|---|---|---|
| GRAMMAR | Literal string, | Provided in order to facilitate |
| | AppSelection, denotes that | concurrent grammars being |
| | the user input matched | activated by an application. |
| | an item in the application | |
| | selection grammar. | |
| APP | The name of the plug-in | Used to get the URL of the |
| | application the grammar | selected application from the |
| | item refers to. | plug-in manager business |
| | | objects. |
| CMD | The name of the plug-in | Used to get the URL of the |
| | application main voice link | selected application from the |
| | the grammar item refers to. | plug-in manager business |
| | | objects. |
| CONFIRM | The URL provided by the | This URL is invoked by the |
| | application to confirm | calling application if the |
| | grammar items. | recognition confidence is low |
| | | enough that the grammar |
| | | results should be confirmed. |
| | | The routine the URL refers to |
| | | is provided by the application |
| | | which provided the grammar |
| | | in order to confirm its |
| | | provided grammar items. |

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system comprising:
a first application operative in response to a certain request received on a communication path for performing a function in accordance with said certain request, said certain request contained in a context associated with said first application;
a second application having associated with it a context different from said first application context; and
control independent from either application and responsive to receipt by said first application of a particular request not in said first application's context but in said second application's context for transferring control of said communication path to said second application so that said second application can perform a function in accordance with said particular request.

2. The system of claim 1 wherein said particular request stems from an implicit prompt.

3. The system of claim 1 where said particular request stems from an explicit prompt.

4. The system of claim 1 where said applications are plug/play applications.

5. The system of claim 4 where said control is further operative to select from a plurality of possible applications having said particular request in its context in accordance with the context in which said particular request was received.

6. The system of claim 5 where said possible applications are only those applications currently plugged into said system.

7. The system of claim 6 wherein said context is a grammar containing a plurality of requests.

8. The system of claim 7 wherein said grammar comprises at least one selected from the list of:
spoken words, typed commands, touch screen response.

9. The system of claim 6 wherein said context is a text menu.

10. The system of claim 6 wherein said context is at least one pull-down menu.

11. The system of claim 10 wherein the selections on said pull-down menus change in correspondence to the then plugged-in applications.

12. A method of operating a UIS system, said method comprising:
receiving commands from a user of a first application, said commands indicating to said application the current desires of said user;
determining when a received command is better suited to an application other than said first application; and
transferring said user to said other application for subsequent receipt of commands from said user.

13. This method of claim 12 wherein said applications are plug/play applications.

14. The method of claim 13 for comprising:
making available to said other application data obtained by said first application pertaining to said user.

15. The method of claim 13 wherein the identity of said other application is unknown to said first application at the time of said transfer.

16. The method of claim 13 further comprising:
marking at said first application the exact place in said first application achieved by said user just prior to said transfer such that if said user returns to said first application said return will be at said marked location within said first application.

17. The method of claim 13 further comprising:
when a received command is determined to be better suited to another application, determining the context of said received command so as to facilitate said transfer to a proper application.

18. The method of claim 12 in which said applications are connected to said UIS system as pluggable applications each application without prior knowledge of the other applications.

19. The method of claim 18 further comprising:
making available to said other application grammars used by said user with said first application.

20. The method of claim 18 further comprising:
making available to said first application grammars pertinent to said other of said applications plugged into said UIS system.

21. The method of claim 18 further comprising:
making available to said other applications text menu selections used by said user with said first application.

22. The method of claim 18 further comprising:
making available to said first application text menu selections pertinent to other of said applications plugged into said UIS system.

23. The method of claim 22 wherein said test menu selections comprise icons.

24. A computer program product for operating an UIS system having a plurality of plug/play applications connected thereto, said computer program product comprising:
code for controlling the receipt of commands from a user of a first plugged in application, said commands indicating to said application the current desires of said user;
code for determining when a received command is better suited to be connected to another plugged in application other than said first plugged in application; and
code for controlling the transfer of said user to said other application for subsequent receipt of commands from said user.

25. The computer program product of claim 24 for comprising:
making available to said other application data obtained by said first application pertaining to said user.

26. The computer program product of claim 25 wherein the identity of said other application is unknown to said first application at the time of said transfer.

27. The computer program product of claim 25 further comprising:
code for controlling the marking at said first application of the place in said first application achieved by said user just prior to said transfer such that if said user returns to said first application said return will be at said marked location within said first application.

28. The computer program product of claim 25 further comprising:
code operable when a received command is determined to be better suited to another application, for determining the context of said received command so as to facilitate said transfer to a proper application.

29. The computer program product of claim 25 wherein said applications are connected to said UIS system as pluggable applications each application without prior knowledge of the other applications.

30. The method of claim 25 further comprising:
code for making available to said other application grammars used by said user with said first application.

31. The method of claim 25 further comprising:
code for making available to said first application grammars used by other applications currently plugged into the system.

32. The method of claim 25 further comprising:
code for adding text menu selections to said applications based upon which applications are plugged into said system at a particular time.

33. A plug and play UIS application comprising:
a sequence of user prompts, said prompts having a particular grammar specific to said plug and play UIS application; and
means for communicating at least a portion of said particular grammar to other UIS applications when said plug and play application is connected to a UIS system such that upon detection of said particular grammar from a user interacting with one of said other UIS applications plugged into said UIS system the user at said other UIS application is transferred to said UIS application.

34. The UIS application set forth in claim 33 further comprising:
means for transferring a user to another application plugged into said system upon detection of a grammar from said user communicated from said another application.

35. The UIS application of claim 33 further comprising:
means for transferring a user to another applications plugged into said system upon detection of a text menu selection from said user, said text menu selection communicated from said another application.

36. A method of operation of an UIS application in a plug/play system, said method comprising:
providing prompts to a user, said prompts having a particular grammar specific to a particular plugged in one of said UIS applications; and
transferring said user to a different application plugged into said system upon receipt of a prompt from a user where said received prompt is in keeping with a grammar broadcast from said different application.

37. The method of claim 36 wherein said broadcast is only while said different application is plugged into said system.

38. The method of claim 37 further comprising:
advertising grammars particular to said application to other applications.

39. The method of claim 37 further comprising:
transferring to said different application data obtained from said user pertinent to said different application.

40. The method of claim 37 further comprising:
advertising menu selections particular to said application to other applications.

41. The method of claim 40 where said menu selections are selected form one list of: text, icons, audio, graphics.
